(19) United States
(12) Patent Application Publication
(10) Pub. No.: US 2023/0255840 A1
(43) Pub. Date: Aug. 17, 2023

(54) LIFT ASSEMBLY FOR A PASSENGER VEHICLE

(71) Applicant: The Braun Corporation, Winamac, IN (US)

(72) Inventors: James R. Dupuy, Kokomo, IN (US); Austin D. Metzger, Rensselaer, IN (US); Michael Alexander, West Lafayette, IN (US)

(21) Appl. No.: 18/165,402

(22) Filed: Feb. 7, 2023

Related U.S. Application Data
(60) Provisional application No. 63/307,841, filed on Feb. 8, 2022.

(51) Int. Cl. A61G 3/02; B66F 7/06; B66F 7/08

(52) U.S. Cl. CPC A61G 3/02; B66F 7/065; B66F 7/08

(57) ABSTRACT

A wheelchair lift for a passenger vehicle such as a passenger bus, a motorcoach, or a class A motorhome. The wheelchair lift includes a housing having sidewalls and a plurality if bearings and a carriage supporting one or more of electrical, mechanical, and hydraulic components. A lift assembly is coupled to the carriage and includes a first rail and a second rail supported by the plurality of bearings. A first scissor leg assembly is coupled to the first rail and a second scissor leg assembly is coupled to the second rail, wherein each of the first scissor leg assembly and the second scissor leg assembly move between an expanded and a collapsed condition. A platform is coupled to the first the second scissor leg assemblies, wherein movement of the first scissor leg assembly and second scissor leg assembly between the expanded and collapsed condition adjusts a position of the platform.

### CROSS REFERENCE TO RELATED APPLICATIONS

This application claims priority to U.S. Provisional Patent Application Ser. No. 63/307,841, filed on Feb. 8, 2022, the contents of which is incorporated herein by reference.

### FIELD OF THE DISCLOSURE

The present application relates to a passenger vehicle for transporting one or more passengers, and more particularly to a modified passenger vehicle having a lift assembly which enables a physically limited passenger using a wheelchair to enter and exit the vehicle.

### BACKGROUND

Vehicle manufacturers do not currently mass-produce passenger motor vehicles specifically designed to transport passengers having physical limitations, either as a driver or as a non-driving passenger. Consequently, mass-produced passenger vehicles are modified, or retrofitted, by a number of aftermarket companies dedicated to supplying vehicles to physically limited passengers. Such vehicles can be modified by adding and/or removing certain parts or structures within a vehicle that are specifically designed to accommodate the physically limited passenger. For example, in one configuration, a van is retrofitted with a ramp to enable a physically limited individual using a wheelchair to enter and exit the vehicle without the assistance of another individual. In another configuration a passenger bus, motorcoach, or a different classes of motorhomes, such as class A motorhome, are retrofitted with a lift assembly that enables a physically limited passenger to enter or to exit the vehicle. In some embodiments, the lift assembly is adapted for a physically limited passengers using a wheelchair or other mobility device.

Known products for retrofitting a vehicle, such as a van, sport utility vehicle, and a bus include lift assemblies, wheelchair lifts, lift platforms, and lowered floor surfaces. In some instances, a door or door entry of an original equipment manufacturer (OEM) vehicle is enlarged or otherwise modified to permit entry and exit of the physically limited individual through what is known as the assisted entrance.

In some instances, the lift assembly is stored below the conventional vehicle floor and is deployed to accommodate entry and exit of the physically limited individual through a side door or other entrance of the vehicle. Challenges may arise related to deploying and stowing the lift assembly and ensuring that the lift assembly moves consistently and repeatedly between the deployed position and the stowed position.

### SUMMARY OF THE EMBODIMENTS

In one embodiment, there is provided a wheelchair lift for a passenger bus including a housing having sidewalls and a plurality of bearings, and a carriage supporting one or more of electrical, mechanical, and hydraulic components. A lift assembly is coupled to the housing wherein the lift assembly includes a first rail and a second rail, the first rail and second rail supported by the plurality of bearings, a first scissor leg assembly coupled to the first rail and a second scissor leg assembly coupled to the second rail. Each of the first scissor leg assembly and the second scissor leg assembly move between an expanded and a collapsed condition. A platform is coupled to the first scissor leg assembly and the second scissor leg assembly, wherein movement of the first scissor leg assembly and second scissor leg assembly between the expanded and collapsed condition adjusts a position of the platform for lifting a wheelchair.

In some embodiments, the wheelchair lift includes wherein the carriage includes a front wall and the first rail and the second rail provide sidewalls of the housing. A cylinder is rotatably coupled to the front wall, wherein the cylinder is coupled to the first scissor leg assembly and to the second leg assembly and rotation of the cylinder expands and collapses the first and second leg assemblies.

In some embodiments, the wheelchair lift includes wherein the first scissor leg assembly includes a first arm coupled to a first end of the cylinder and a second arm coupled to a second end of the cylinder, wherein rotation of the cylinder adjusts the position of the first arm and the second arm.

In some embodiments, the wheelchair lift includes wherein the carriage includes a first actuator having a first piston rod coupled to the first arm and second actuator having a second piston rod coupled to the second arm, wherein extension and retraction of the first piston rod and the second piston rod rotates the cylinder to expand and to collapse the first and second leg assemblies.

In some embodiments, the wheelchair lift further includes a guide rail coupled to the housing, wherein the guide rail supports a chain and the carriage includes a motor, and wherein the chain is coupled to the motor and the motor upon actuation drives the chain to move the lift assembly to a stowed position.

In some embodiments, the wheelchair lift further includes a locator coupled to the bus, wherein the locator receives the housing in the stowed position.

In some embodiments, the wheelchair lift includes wherein the first scissor leg assembly includes a third arm rotatably coupled to the first arm and the second scissor leg assembly includes a fourth arm rotatably coupled to the second arm, wherein the third arm is slidably connected to the first rail and the fourth arm is slidably connected to the second rail.

In some embodiments, the wheelchair lift includes wherein the first arm and the second arm are each slidably connected to the to the platform.

In some embodiments, the wheelchair lift includes wherein the third arm includes a first segment fixedly connected to a second segment at a pivot location at the first arm, wherein the first segment is slidably connected to the first rail and the second segment is rotatably coupled to the platform.

In some embodiments, the wheelchair lift includes wherein the fourth arm includes a first segment fixedly connected to a second segment at a pivot location at the second arm, wherein the first segment is slidably connected to the second rail and the second segment is rotatably coupled to the platform.

In some embodiments, the wheelchair lift further includes a first switch having a contact arm and the cylinder includes a plate coupled thereto and located in proximity of the contact arm, wherein rotation of the cylinder rotates the plate into and out of contact with the contact arm to identify a position of the first arm and the second arm.

In some embodiments, the wheelchair lift further includes a second switch having a roller arm and the housing includes a contact plate, wherein movement of the carriage adjusts a position of the second switch with respect to the contact plate of the housing to stop movement of the carriage at the extended position.

In some embodiments, the wheelchair lift further includes a third switch having a roller arm and the locator includes a contact plate, wherein movement of the carriage adjusts a position of the third switch with respect to the contact plate of the locator to stop movement of the carriage at the stowed position.

In some embodiments, the wheelchair lift includes wherein the carriage includes a motor and wherein the first switch, the second switch and the third switch, are each operatively connected to the motor.

In another embodiment, there is provided a passenger bus including a body having an entrance and a storage compartment located below the entrance. A wheelchair lift includes a stowed position located within the storage compartment and a deployed position extending from the storage compartment wherein the wheelchair lift includes a housing having sidewalls and a plurality if bearings and a carriage supporting one or more of electrical, mechanical, and hydraulic components. A lift assembly is coupled to the housing, wherein the lift assembly includes a first rail and a second rail. The first rail and the second rail are supported by the plurality of bearings. A first scissor leg assembly is coupled to the first rail and a second scissor leg assembly is coupled to the second rail, wherein each of the first scissor leg assembly and the second scissor leg assembly move between an expanded and a collapsed condition. A platform is coupled to the first scissor leg assembly and the second scissor leg assembly, wherein movement of the first scissor leg assembly and second scissor leg assembly between the expanded and collapsed condition adjusts a position of the platform.

In some embodiments, the passenger bus includes wherein the carriage includes a front wall and the first rail and the second rail provide sidewalls of the housing, and a cylinder rotatably coupled to the front wall, wherein the cylinder is coupled to the first scissor leg assembly and to the second leg assembly and rotation of the cylinder expands and collapses the first and second leg assemblies.

In some embodiments, the passenger bus includes wherein the first scissor leg assembly includes a first arm coupled to a first end of the cylinder and a second arm coupled to a second end of the cylinder, wherein rotation of the cylinder adjusts the position of the first arm and the second arm.

In some embodiments, the passenger bus includes wherein the carriage includes a first actuator having a first piston rod coupled to the first arm and second actuator having a second piston rod coupled to the second arm, wherein extension and retraction of the first piston rod and the second piston rod rotates the cylinder to expand and to collapse the first and second leg assemblies.

In some embodiments, the passenger bus further includes a guide rail coupled to the housing, the guide rail supporting a chain and the carriage includes a motor, wherein the chain is coupled to the motor and the motor upon actuation drives the chain to move the lift assembly to a stowed position.

In some embodiments, the passenger bus further includes a locator coupled to the bus, wherein the locator receives the carriage in the stowed position.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 illustrates an elevational perspective view of a passenger vehicle including a wheelchair lift assembly;

FIG. 2 illustrates a perspective view of one embodiment of a wheelchair lift assembly including a

FIG. 3 illustrates a perspective view of a lift assembly in a loading position;

FIG. 4 illustrates a perspective view of a connection for a two piece arm;

FIG. 5 illustrates a sectional view of a connection for a two piece arm.

FIG. 6 illustrates a perspective view of a lift assembly in a collapsed position fully extended from a housing;

FIG. 7 illustrates perspective view of a lift assembly in a collapsed position partially extended from a housing.

FIG. 8 illustrates a perspective view of housing facing a carriage.

FIG. 9. illustrates a housing supporting components to control operation of the lift assembly.

FIG. 10 illustrates a chain drive and a locking mechanism for the chain drive.

FIGS. 11A and 11B illustrate a locking mechanism for a chain drive.

FIG. 12 illustrates a position assembly for determining a position of a lift assembly.

FIG. 13 illustrates a switch assembly for determining a position of a lift assembly.

FIG. 14 illustrates a barrier in a raised position.

FIG. 15 illustrates features of a barrier adjuster for a barrier.

FIG. 16 illustrates features of the barrier adjuster of FIG. 15.

FIG. 17 illustrates a barrier position indicator coupled to a sidewall and to a barrier of a lift assembly.

FIG. 18 illustrates an exploded view of a barrier position indicator coupled to a sidewall and to a barrier of a lift assembly.

FIG. 19 illustrates a cross-sectional view of a barrier adjuster and a barrier position indicator.

FIG. 20 is a block diagram of a control system including a controller having a processor and a memory.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

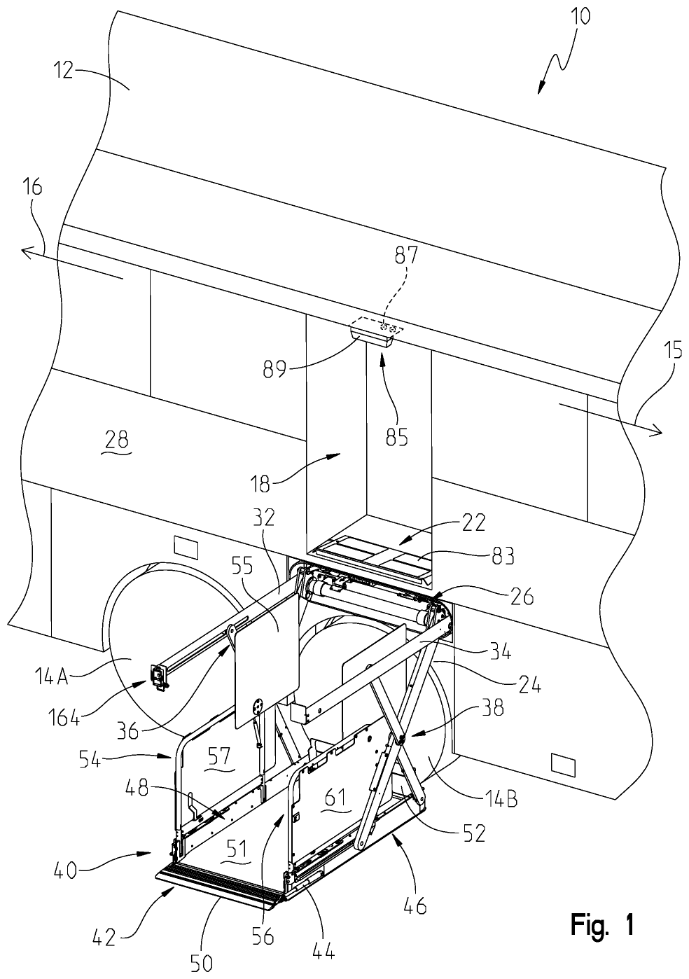

FIG. 1 illustrates a vehicle 10, commonly identified as a passenger bus, available from any number of United States and foreign manufacturers. In the illustrated embodiment, the vehicle 10 includes one type of body construction, but other vehicles having other types of body constructions, are also contemplated for the present disclosure. Consequently, the use of a vehicle herein includes all types and kinds of passenger vehicles including buses, motorcoaches, and class A motorhomes. In addition, while the vehicle 10 is illustrated in FIG. 1 as a bus, the present disclosure is directed to all passenger vehicles carrying one or more passengers.

The vehicle 10 includes a body 12 operatively coupled to wheels 14 that engage a road surface. The entire body 12 is not shown for ease of illustration, but a front portion of the bus 10 extends in a direction 15 away from the wheels 14 and a rear portion of the bus extends in a direction 16. Front wheels are not shown and the wheel 14A is one of a set of rear wheels and the wheel 14B is one of a set of middle wheels and is located between the front wheels and the rear wheels 14A. A passenger entrance 18 is located above the middle wheels and typically includes a door, not shown, that opens and closes to enable a passenger to enter and to exit the vehicle 10.

A ski locker compartment 20 is located below the entrance 18 and a floor 22 is located above the compartment 20 to provide a support surface for a passenger. The ski locker 20, as provided by an OEM manufacturer, is used to store skis, but in this embodiment the ski locker compartment 20 is used to stow a wheelchair lift 24. While the present embodiment is illustrated to use a ski locker compartment 20 for stowing the wheelchair lift 24, other embodiments include other types of compartments configured to stow the wheelchair lift 24. In addition, other locations of the compartment 20 are contemplated including compartments not located above wheel 14B, but located along the length of the vehicle 10, as well as a compartment located at the rear of the vehicle 10.

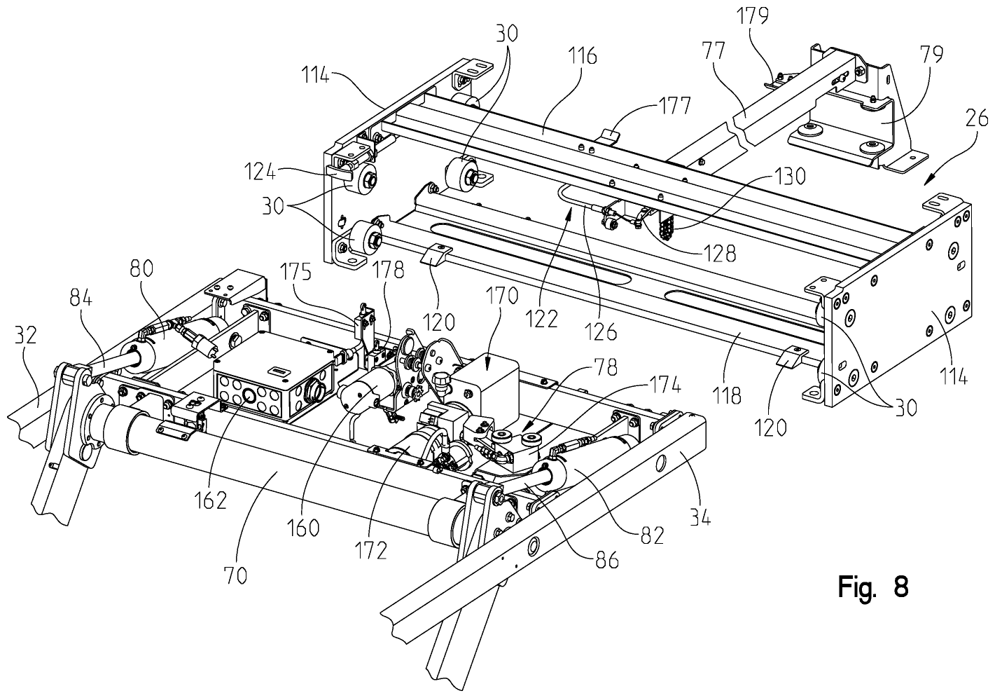

The wheelchair lift 24 includes a housing 26 that is fixedly located in the compartment 20. The compartment 20 extends from a first side 28 of the vehicle 10 towards a second side of the vehicle, not shown. The housing 26 is located at the first side 28 of the vehicle 10 and the wheelchair lift 24 is stowed and deployed by the housing 26. The housing 26 includes a plurality of roller bearings 30 described later in FIG. 8 upon which a first rail 32 and second rail 34 of the wheelchair lift 24 are supported as the wheelchair lift 24 is stowed and deployed from the housing 26 and the compartment 20.

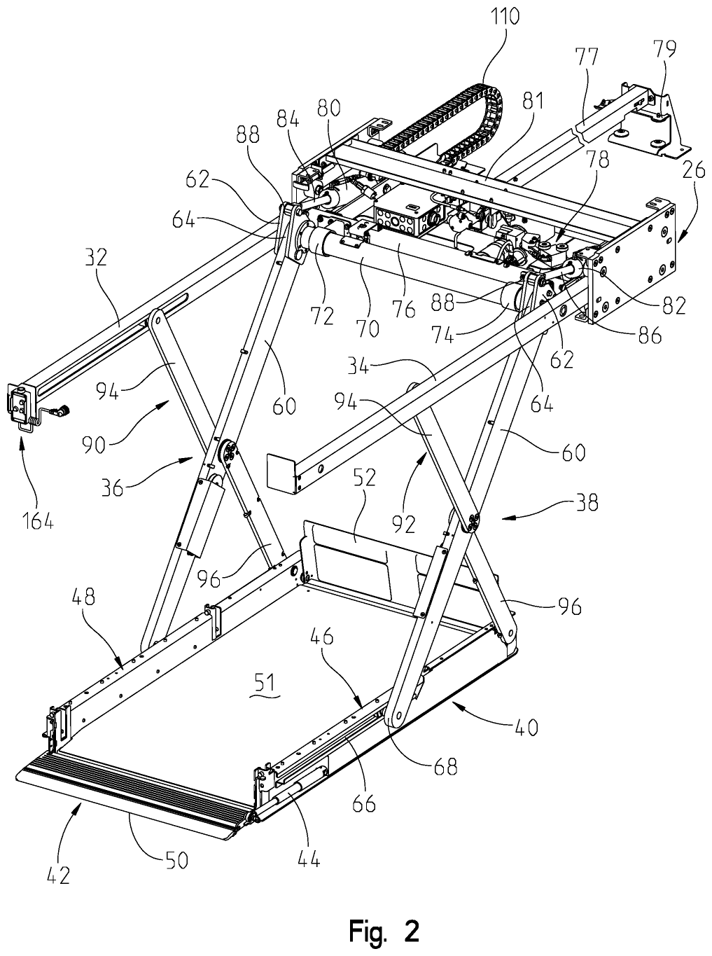

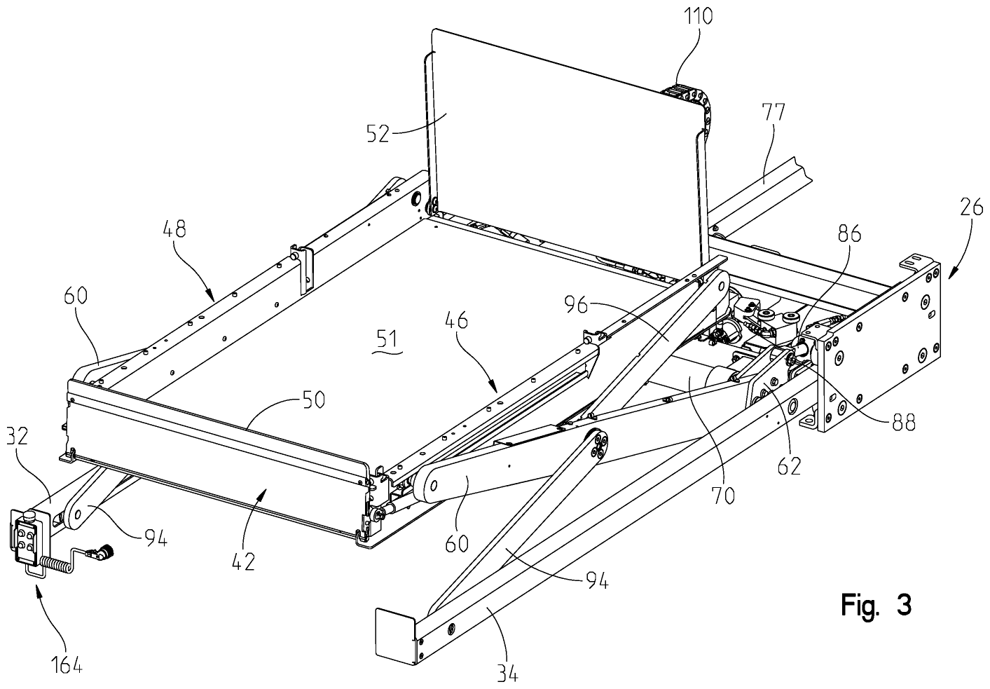

The wheelchair lift 24 as seen in FIGS. 1 and 2 further includes a first scissor leg assembly 36 coupled to the first rail 32 and a second scissor leg assembly 38 coupled to the second rail 34. A platform 40 is coupled to each of the first scissor leg assembly 36 and the second scissor leg assembly 38. A ramp plate 42 is rotatably coupled to the platform 40 and moves between a lowered position as illustrated in FIGS. 1 and 2 and to a raised position as illustrated in FIG. 3.

The ramp plate 42 is raised and lowered by an electric actuator 44 connected to the ramp plate 42 and to a first sidewall 46 of the platform 40. A second sidewall 48 of the platform 40, in one embodiment, does not support a gas spring for positioning of the ramp plate 42, but in other embodiments, a gas spring is connected between the ramp plate 42 and the second side wall 48. The ramp plate 42 includes an inclined front edge 50 to provide for a gradual transition of wheels of a wheelchair between the road surface, for instance, and a platform plate 51. A barrier 52 is rotatably coupled to the platform plate 51 at an end of the platform plate 51 opposite the end at which the ramp plate 42 is located. A first handrail assembly 54 and second handrail assembly 56 move between open and closed positions. Hand rail assembly 54 includes an upper panel or shield 55 and a lower panel or shield 57. Handrail assembly 56 includes an upper panel or shield 59 and a lower panel or shield 61. Handrail assemblies 54 and 56 are further disclosed in co-pending patent application entitled “Lift Assembly with Handrails for a Passenger Vehicle” filed on the same day as this patent application, which is incorporated in its entirety by reference herein. For additional features of the handrail assemblies 54 and 56, please see the co-pending application.

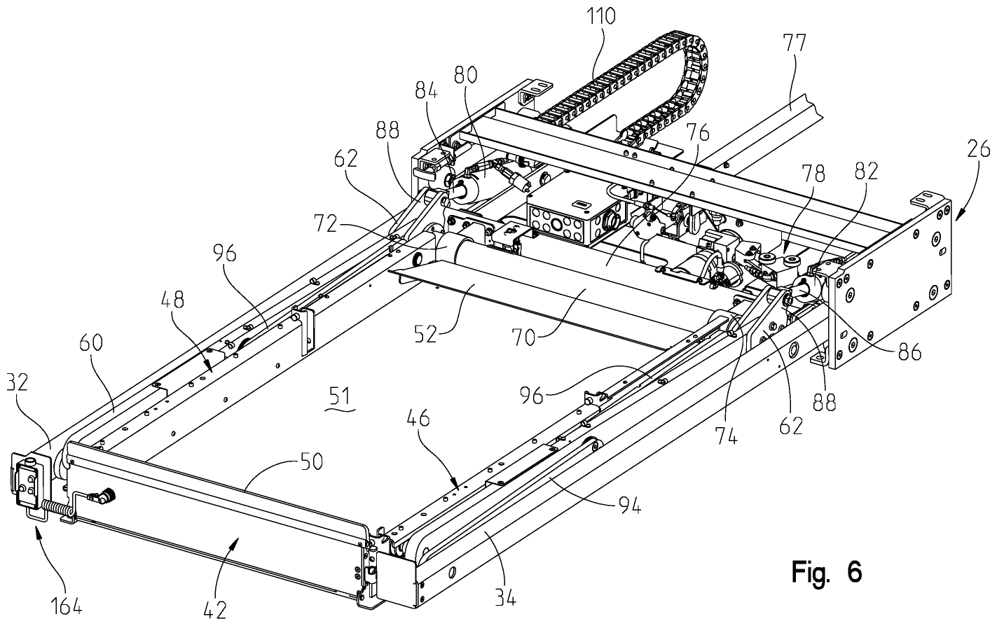

As further seen in FIG. 2, each of the first scissor leg assembly 36 and the second scissor leg assembly 38 are similar in construction and a following description of scissor leg assembly 36 applies to a description of the other scissor leg assembly 38. Each of the scissor leg assemblies 36 and 38 include an arm 60 extending between a bracket 62, located at one end 64 of the arm 60, and a slot 66 at which another end 68 of the arm 60 is slidingly coupled. The end 68 slides along the slot 66 as the wheelchair lift 24 moves between a deployed position as illustrated in FIGS. 1 and 2 and a collapsed position as illustrated in FIG. 6. A roller bearing 69 is attached to the end 68 and enables the sliding movement of the end 68 of arm 60 along the slot 66.

The brackets 62 are each fixedly connected to ends 64 of the arms 60. A cylinder 70 extends between brackets 62. The cylinder 70 is fixedly connected to the brackets 60 such that rotation of the cylinder 70 moves the wheelchair lift 24 between the deployed position and the collapsed position used for the stowed position. The cylinder 70 is rotatably coupled to the carriage 26 with a first ring bracket 72 and a second ring bracket 74 each of which are fixedly coupled to a bar 76 of a carriage 78, that supports electrical, mechanical, and hydraulic components, as described herein. Ends of the first rail 32 and the second rail 34 are fixedly connected to the bar 76 to form sides of the carriage 78. A plate or other supporting structure, not shown, extends from the bar 76 and between the first rail 32 and the second rail 34 to support the components located at the carriage 78. In different embodiments, the cylinder 70 includes one of a hollow tube or a solid rod. Hydraulic cylinders 80 and 82 connected to 62 raise and lower the lift assembly.

The carriage 78 moves with respect to the housing 26 in response to a chain supported by a guide rail 77. The chain moves the carriage 78 along the guide rail 77 from the fully deployed position of FIG. 1 to the collapsed position for being stowed wherein the complete wheelchair lift 24 is located within the ski locker. The guide rail 77 is supported within the ski locker by a locator 79 that is fixedly attached to an interior of the ski locker. The opposite end of the guide rail 77 is coupled to a support 81 of the housing 26 and the locator 79. Since both the housing 26 and the locator 79 are fixed within the ski locker, the guide rail 77 is also fixed within the ski locker and provides for movement of the carriage 78 and the wheelchair lift 24.

A first hydraulic actuator 80 and a second hydraulic actuator 82 are supported at the carriage 78 and each includes respectively a piston rod 84 and a piston rod 86. The rods 84 and 86 are rotatably connected to brackets 62 of the scissor arms 60. Since the pivoting locations of the rods 86 and 88 are offset from a center longitudinal axis of the cylinder 70, actuation of the first and second hydraulic actuators 80 and 82 rotates the cylinder 70 within the first ring bracket 72 and a second ring bracket 74 to move the platform 40 from a first position of FIG. 2, for moving the individual between the road surface and the platform 40, to a second position of FIG. 3, for moving the individual between the platform 40 and the floor 22, to a third position of FIG. 6, for stowing the wheelchair lift 24 in the bus 10.

In the first position of FIG. 2, the rods 84 and 86 are fully extended and the arms 60, which are rotatably coupled two piece arms 90 and 92, have moved the platform 40 to the position of FIG. 2. This position is typically used to enable an individual in a wheelchair to move onto the platform plate 51. As the rods 84 and 86 are retracted, the platform 40 is raised from the position of FIG. 2 to a loading/unloading position as illustrated in FIG. 3. In this position, the rods 84 and 86 are fully retracted and the platform 40 has moved from a position below a plane defined by the first rail 32 and second rail 34 to a position above the plane defined by the first rail 32 and second rail 34. The platform 40 in this position is located at a level of the floor 22 of the vehicle 10.

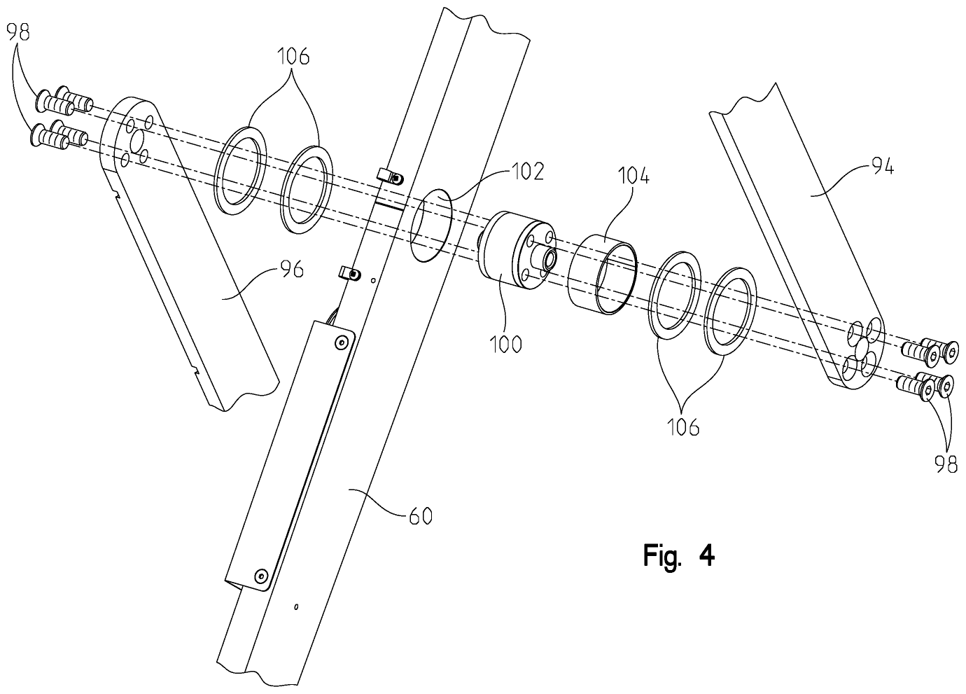

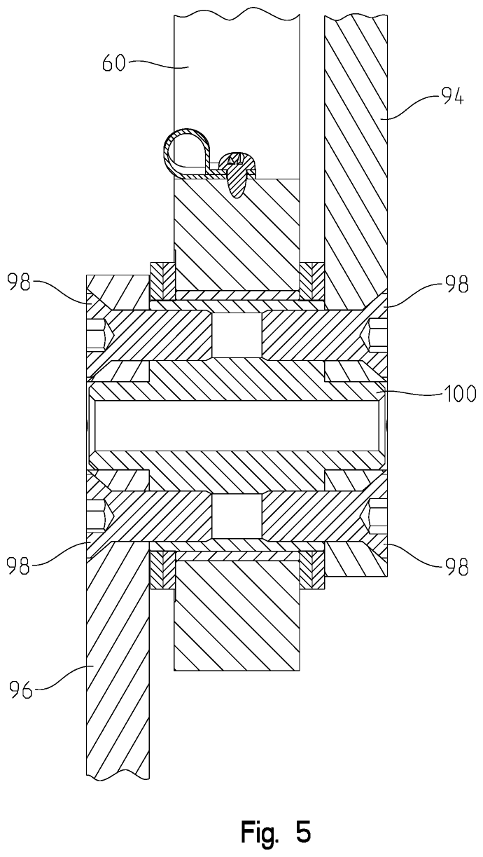

The two piece arms 90 and 92 each include a first section 94 and a second section 96. the first and second sections 92 and 96 are fixedly connected to one another with connectors 98 that that extend through the first section 92, the second section 96 and the arm 60. These connectors 98, while fixedly coupling the first and second section 94 and 96, also rotatably couple the combined first and second sections 94 and 96 to the arms 60. A center pivot 100 (see FIG. 4) is located in an aperture 102 located in the arms 60. The rotatable center pivot 100 is held in place by each of the arms 94 and 96 and the connectors 98. A sleeve 104 fits within the aperture 102 to locate the center pivot 100. Washers 106 provide additional structural support for positioning the center pivot 100 within the aperture 102. Further details of the connection between the arm 60 and the arms 94 and 96 are illustrated in the cross-sectional view of FIG. 5.

In this embodiment, the scissor leg assemblies 36 and 38 move between a fully expanded configuration of FIG. 2, a partially expanded configuration of FIG. 3, and a fully collapsed configuration of FIG. 6. As seen in FIG. 6, as the wheelchair lift 24 is moved from the position illustrated in FIG. 3, the barrier plate 52 is moved towards the platform plate 51. As the wheelchair lift 24 moves toward the stowed position, the wheelchair lift 24 is further retracted to be located within the housing 26. In this position, the barrier plate 52 is moved to a position substantially planar with respect to the platform plate 51. A flexible cable support 110 supports various electrical cables that are connected to electrical connectors 112 and to electrical components supported by the carriage 78.

A transition plate 83 is affixed at a threshold of the vehicle defined by the floor 22 and provides a smooth and relatively seamless transition for a wheelchair to move over the barrier 52 when the barrier 52 is level with the floor 22. A threshold module 85 is located at a ceiling of the vehicle 10 and includes an ultrasonic sensor 87 and a strobe/alarm 89. The ultrasonic sensor 87 includes a transmitter and receiver, as is understood by those skilled in the art, and identifies whether an individual is located at the threshold, i.e. beneath the sensor 87. If an individual, or other object, is identified there and the platform 40 is not level with the floor, the strobe/alarm 89 is actuated to indicate that an undesirable condition may be occurring.

FIG. 8 further illustrates the components of the carriage 78 and the carriage's interface with the housing 26. In this illustration, the platform 40 (not shown) is in the deployed position and the housing 26 is displaced from the carriage 78. As seen in FIG. 8, the housing includes sidewalls 114, each of which support four (4) of the roller bearings 30 which are generally positioned to direct the first rail 32 and the second rail 34 through the housing 26 as the wheelchair lift 24 moves between the deployed and stowed positions. The housing 26 further includes a top support bar 116 and a bottom support bar 118, each of which are coupled to the sides 114. The bottom support bar 118 includes inclined tabs 120 which engage the platform 40 as it enters the housing 26 to improve the transition of the carriage moving from outside the housing 26 to the inside of housing 26. The top support bar 116 supports a latching mechanism 122 including a manually operated handle 124 connected to a cable 126 that actuates a lever arm 128. The lever arm 128 engages a chain 130 that provides a chain drive which is directed and supported by the guide rail 77. The lever arm 128, in one position, enables the chain 130 to move along the guide rail 77 for moving the carriage 78 with respect to the housing 26 and in a second position prevents movement of the chain 130 thereby preventing movement of the carriage with respect to the housing 26. In one embodiment, the handle 124 is typically pulled away from the housing 26 when the wheelchair lift 24 is stowed in the ski locker to allow movement of the carriage 78. In one or more embodiments the chain 130 includes a belt, a rope, or a cord.

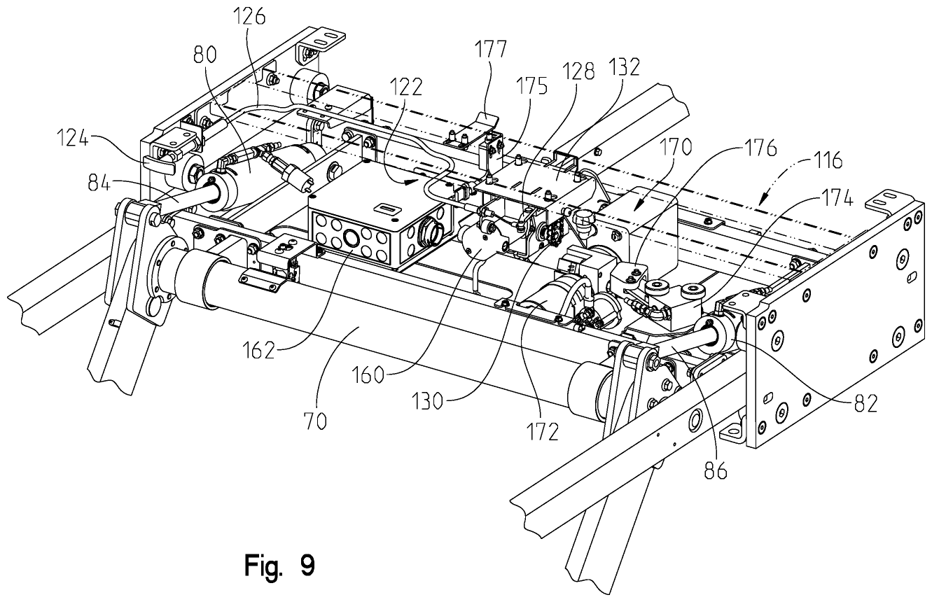

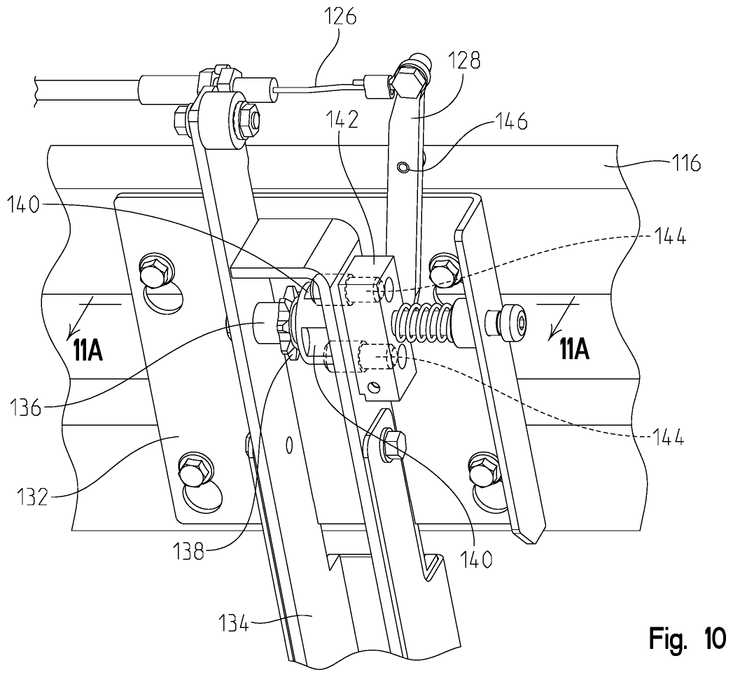

As seen in FIGS. 9 and 10, the top support bar 118, illustrated in dashed lines (phantom view), supports the latching mechanism 122, which further includes a support plate 132 coupled to the top support bar 116. The support plate 132 includes a chain bracket 134 that rotatably supports a chain drive 136 and locking mechanism. The chain drive 136 includes a sprocket 138 that supports the chain 130 for movement. The chain sprocket 138 includes four recesses 140, two of which are shown. A block 142 supports two pins 144 which engage two of the recesses 140 to prevent the chain from moving, i.e. lock the chain in place. The block 142 moves in response to movement of the lever arm 128 which pivots about a pivot axis 146 where the lever arm 128 is pivotally connected to the top support bar 116.

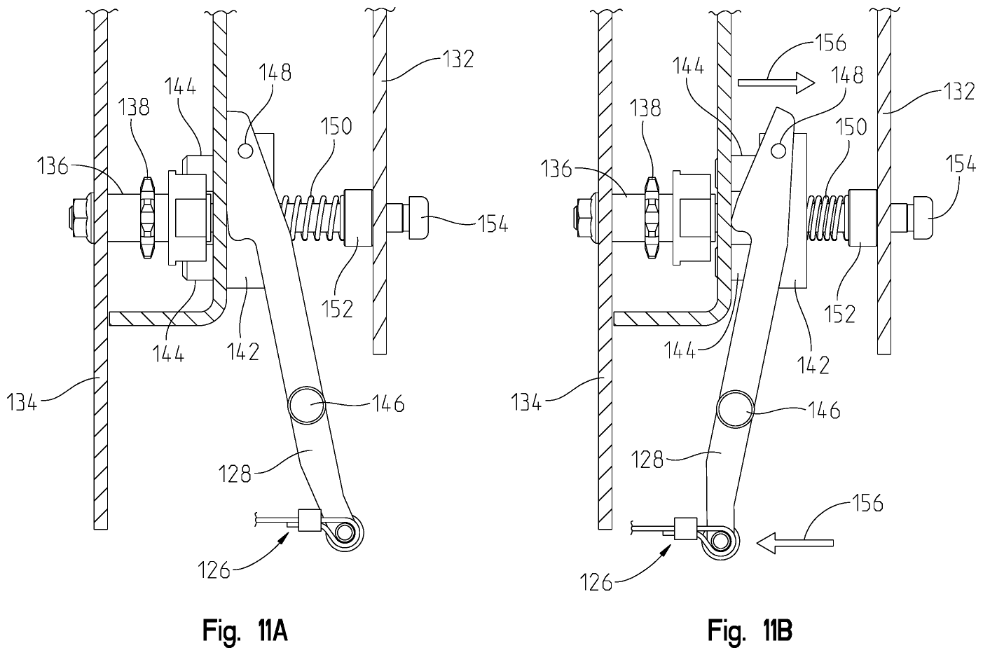

As further seen in FIGS. 11A and 11B, the lever arm 128 is pivotally coupled to the block 142 at a pivot 148. A resilient member 150, such as a spring, is located between the block 142 and a sleeve or washer 152 which is located between the spring 150 and a portion of the support plate 132. A pin 154 extends through the support plate 132, the sleeve 152, and the spring 150. In FIG. 11A, the arm 128 pushes the pins 144 to engage the chain drive 136 to prevent the sprocket 138 from moving. In FIG. 11B, the arm 128 is moved in a direction 156 which pulls the pins 140 from the recesses 140 which allows the sprocket 138 and therefore the chain 130 to move.

Returning to FIGS. 8 and 9, the carriage 78 further supports a motor 160 electrically coupled to a controller 162 which is electrically connected to a power supply of the vehicle 10. In one embodiment, the controller 162 includes electronics configured to turn the motor 160 on and off in response to commands issued through a wired controller or pendant 164. See FIGS. 2 and 3 in particular for controller 164. In one embodiment, the wired controller 164 includes a number of different user interface buttons to control operation of the wheelchair lift 24. For instance, the buttons generate control signals to drive the motor 160 for moving the between a deployed position for a wheelchair occupant to move onto the platform 40 from the ground (See FIG. 1), to an unloading position (See FIG. 3), and to a stowed positon where the wheelchair lift 24 is fully collapsed (See FIG. 6) for moving into the ski locker for storage.

The carriage 78 also supports a hydraulic pump assembly 170 including a hydraulic pump 172 which is operatively connected to the first actuator 80 and the second actuator 82. Hydraulic connections are not shown, but are understood by those skilled in the art. A manually actuated hydraulic pump 174 is also hydraulically coupled to the actuators 80 and 82 which are used to adjust a position of the wheelchair lift 24 in the event that the hydraulic pump 172 becomes inoperable. A manual pump actuator 176 is coupled to the manually actuated hydraulic pump 174 and is used to move hydraulic fluid through the pump 174 and to the actuators 80 and 82. An arm (not shown) is inserted into the actuator 176 and reciprocal movement of the arm moves the actuator 176 to adjust positions of the actuators 80 and 82.

As seen in FIG. 9, the carriage 78 also supports a first limit switch 175 having a contact wheel located for contact with a bracket 177 and a second limit switch 178 located for contact with a bracket 179. As the carriage 78 moves towards the housing 26, contact of the contact wheel of the limit switch 175 provides a signal to the controller 162 to indicate the location of the carriage 78 with the housing. As the carriage 78 continues to move toward the locator 79, contact of the contract wheel of limit switch 178 with the bracket 179 provides a signal to the controller 162 to indicate that the carriage 78 has reached its end of travel for stowing the lift assembly 24 and has properly docked with the locator 79.

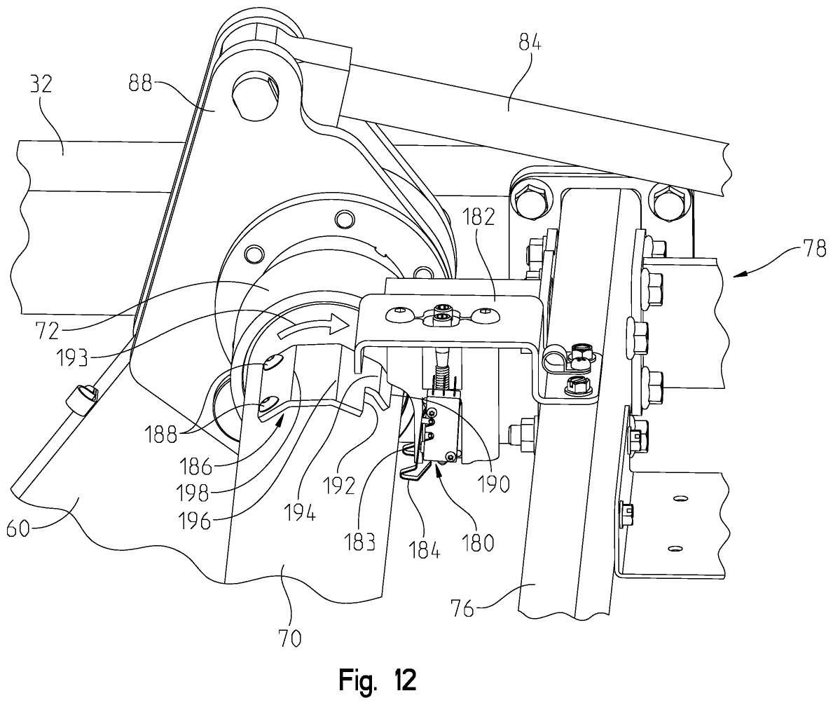

In FIG. 12, the carriage 78 further supports a switch assembly 180 supported by a bracket 182 connected to the bar 76 of the housing 78 for determining the position of the lift assembly 24. The switch assembly 180 includes a first arm 183 and second arm 184 each of which are located adjacently to an indicator plate 186 fixedly connected to the cylinder 70 by connectors 188. As the actuators 80 and 82 rotate the cylinder 70 within the first ring bracket 72 and the second ring bracket 74, the indicator plate 186 moves with respect to the switch assembly 180 which is fixed with respect to the cylinder 70. In different embodiments, switch assembly 180 includes a single switch having two arm or two switches having one arm.

The indicator plate 186 is curved to generally fit the curved surface of the cylinder 70 and includes a first leading edge 190 and a second leading edge 192. As cylinder 70 rotates in a direction 193, the first leading edge 190 depresses the first arm 183 which transmits a signal to the controller 162. The second leading edge 192 depresses the second arm 184 which also transmits a signal to the controller 162. The controller 162 using the transmitted signal information consequently determines the position of the platform 40. The leading edge 192 and the second arm 184 are used to detect floor level position. The leading edge 190 and the first arm 183 are used to detect the stow level position. Edges 196 and 198 are bend lines to enable the plate 186 to fit the outer surface of the cylinder 70.

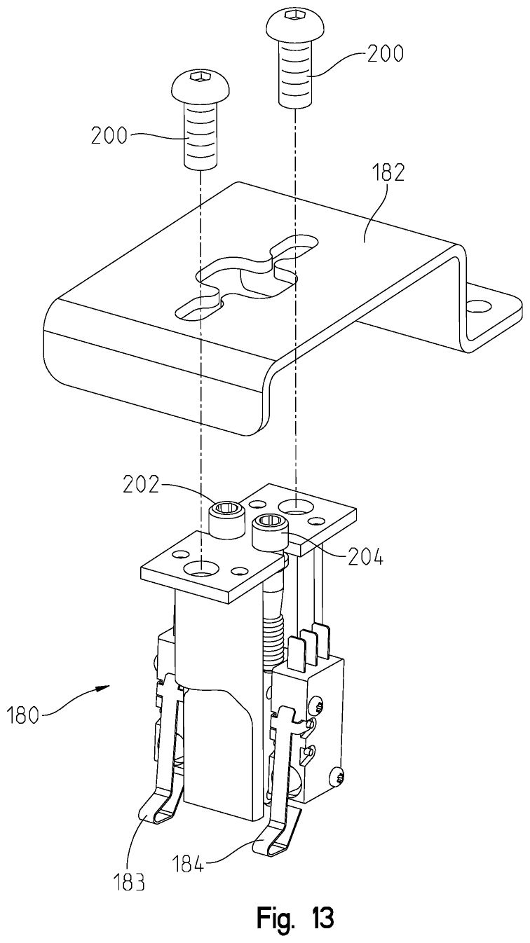

The switch assembly 184, as illustrated in FIG. 13 is fixedly coupled to the bracket 182 with connectors 200. The bracket 182 includes an aperture that accepts the connectors 200 as well as provides access to a first adjuster 202 and a second adjuster 204. Each adjuster 202 and 204 respectively adjusts a physical position of arms 183 and 184 with respect to the indicator plate 186. With proper adjustment, each arm 183 and 184 transmits a signal to the controller 120 when the arm engages the edge 190 or the edge 192. When the arms 183 and 184 not contacting 186, the switches do not transmit signals.

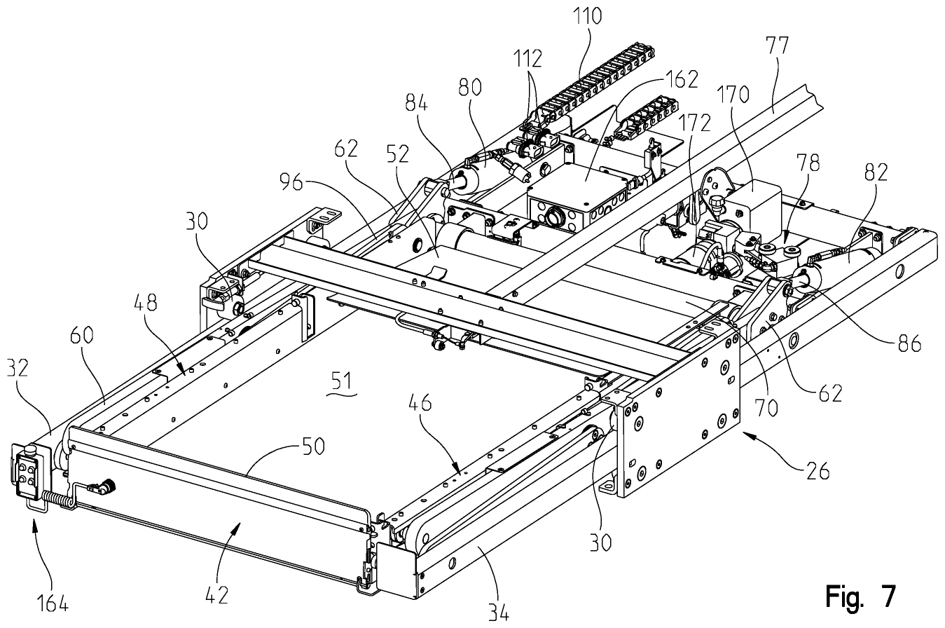

As seen in FIGS. 2, 3, 6, and 7 the barrier 52 is adjustable between different positions depending on the location of the platform 40 depending on which position the wheelchair lift 24 is located. For instance in FIG. 1, the barrier 52 is adjusted to a position such that the surface of the barrier 52 is generally perpendicular to the platform plate 51. In FIG. 7, the barrier 52 is generally planar with respect to the platform plate 51. For each of the positions, the barrier 52 is moved by an electric actuator of the wheelchair lift 24 as it moves from position to position.

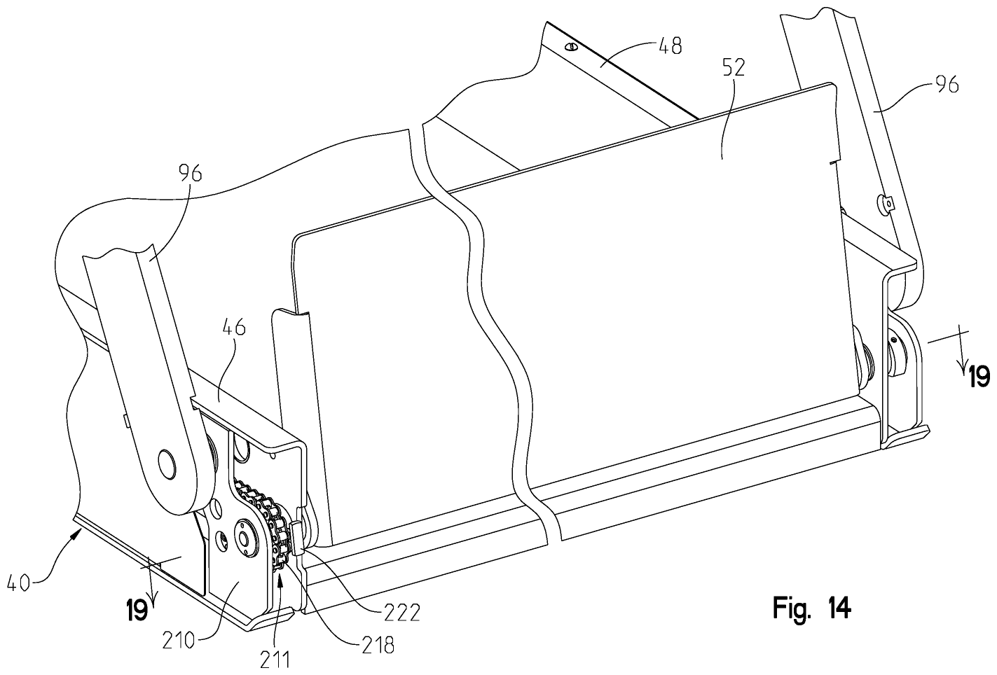

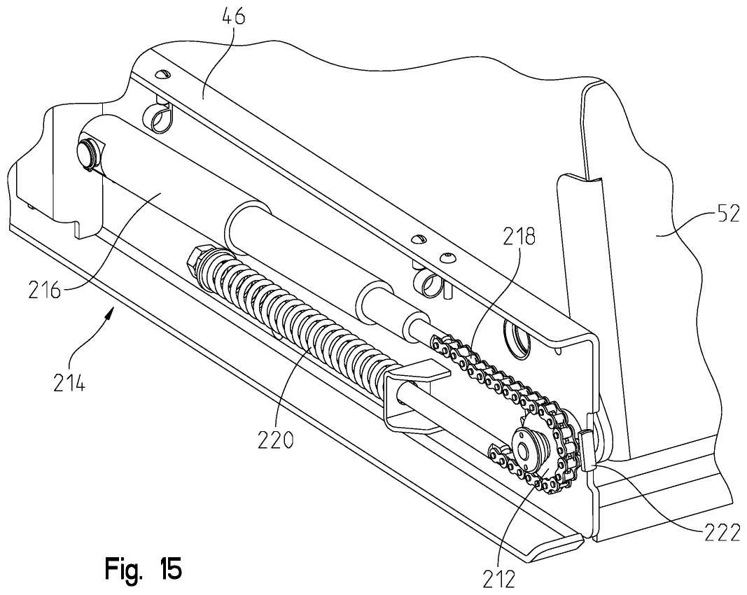

FIGS. 14 and 15 illustrate the barrier 52 for the position illustrated in FIG. 1. In this position, each of the arms 96 is inclined with respect to the platform 40 in which a cover plate is removed to show a bracket 210 and a portion 211 of the sidewall 46 that rotatably supports a sprocket 212. The arm 96 is also rotatably supported by the bracket 210. The sprocket 212 is part of a barrier adjuster 214 that includes a barrier actuator 216 coupled to the sidewall 46 at one end and coupled to a chain 218 at another end. A chain 218 engages the sprocket 212 and is connected to a resilient member 220, i.e. a spring, which maintains a tension on the chain 218 to help ensure that the chain 218 remains on the sprocket while rotating the barrier 52 between the stowed and deployed floor level position. The actuator 216 rotates the barrier in the opposite direction. A pin 222 is removed from the chain/sprocket to rotate the barrier 52 manually. When the barrier 52 is moved manually to a preferred positon by an individual operating the wheelchair lift 24, the position of the barrier 52 is maintained in place by the barrier adjuster 218.

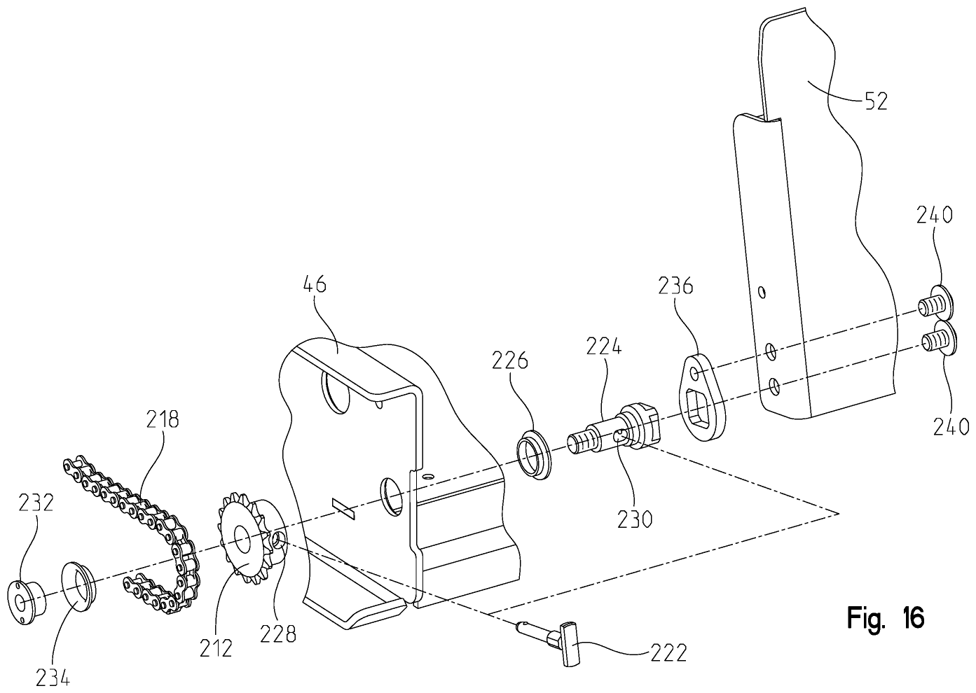

FIG. 16 illustrates additional features of the barrier adjuster 214 including the pin 222 that is inserted into an aperture 224 located in the sprocket 212. A shaft 224 for supporting rotational movement of the barrier extends through a bearing 226, the sidewall 46. The shaft 224 is fixedly held to the sprocket 212 by the pin 222 that extends through an aperture 228 of the sprocket and an aperture 230 of the shaft 224. A cap 232 and a bearing 234 are coupled to the sprocket 228. A bracket 236 is fixedly connected to the barrier 52 by connectors 240 to maintain the position of the shaft with respect to the barrier 52.

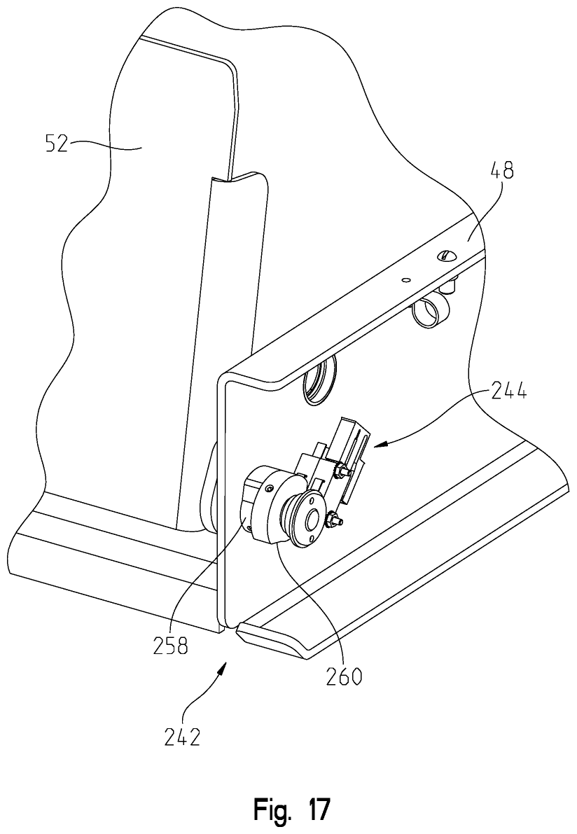

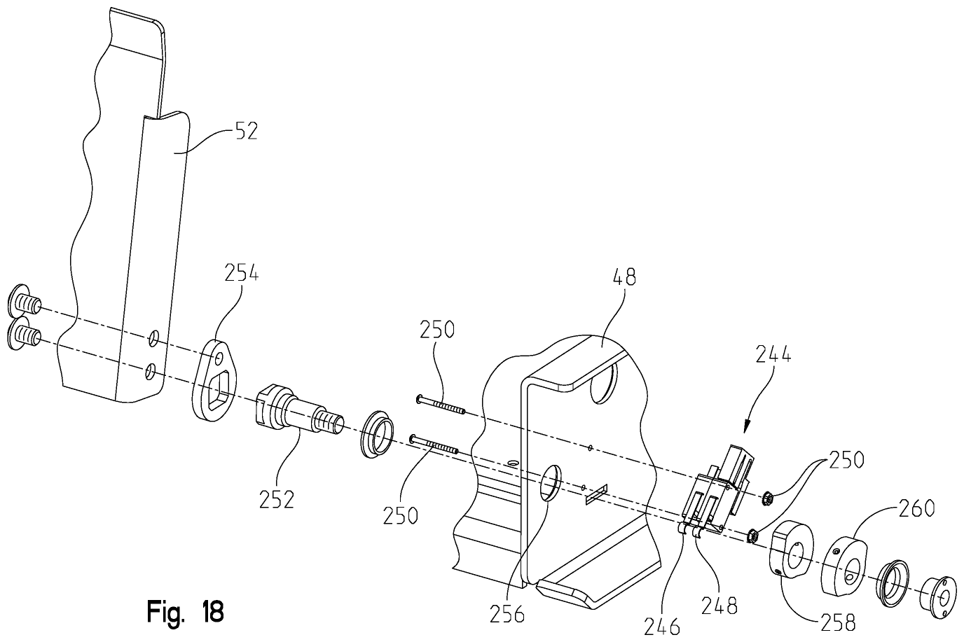

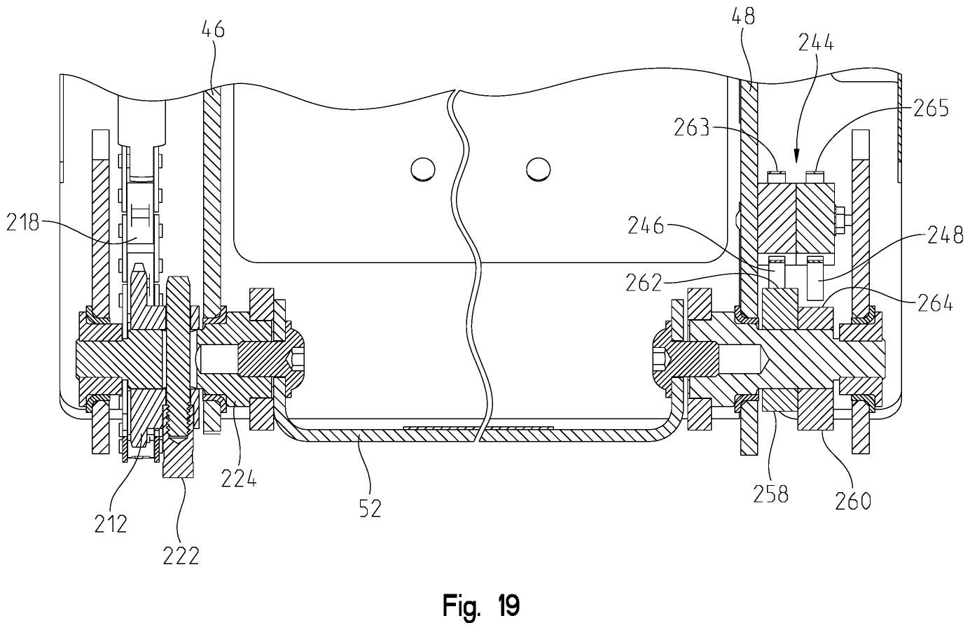

FIGS. 17, 18 and 19 illustrate a barrier position indicator 242 coupled to the sidewall 48 and to the barrier 52. FIG. 19 illustrates a cross-sectional view of the barrier adjuster 214 and the barrier position indicator 242. As illustrated in those figures, the barrier position indicator 242 includes a switch assembly 244 having a first arm 246 and a second arm 248. The switch 244 is fixedly connected to the sidewall 48 with connectors 250. A spindle 252, attached to the barrier 52 by a bracket 254, is inserted through an aperture 256 to engage a first cam 258 and a second cam 260. Each of the cams 258 and 260 are fixedly connected to the spindle 252 and as the barrier 52 is moved between various positions, the cams 258 and 260 respectively move the arms 246 and 248 of the switches 244. Each of the cams 258 and 260 include contacting surfaces having ridges. The ridges of the adjacent cams 258 and 260, which are offset along the pivot axis of the spindle 252, contact the arms 246 and 248 at different positions of the barrier 52. As each of the arms 246 and 248 are depressed, the switches 244 transmits a signal to the controller 162. Upon receipt of the signals, the controller 162 determines the position of the barrier 52. For instance as seen in FIG. 19, cam 258 includes a ridge 262 in contact with the arm 246. The arm 246 is depressed and the switch 244 transmits a signal to the controller 162 through electrical contact 263 indicating a first position of the barrier 52. At the same time a ridge 264 of cam 260 is not in contact with arm 248 and no signal is transmitted through electrical contact 265 of switch 244. In different embodiments, switch assembly 244 includes a single switch having two arm or two switches each having one arm.

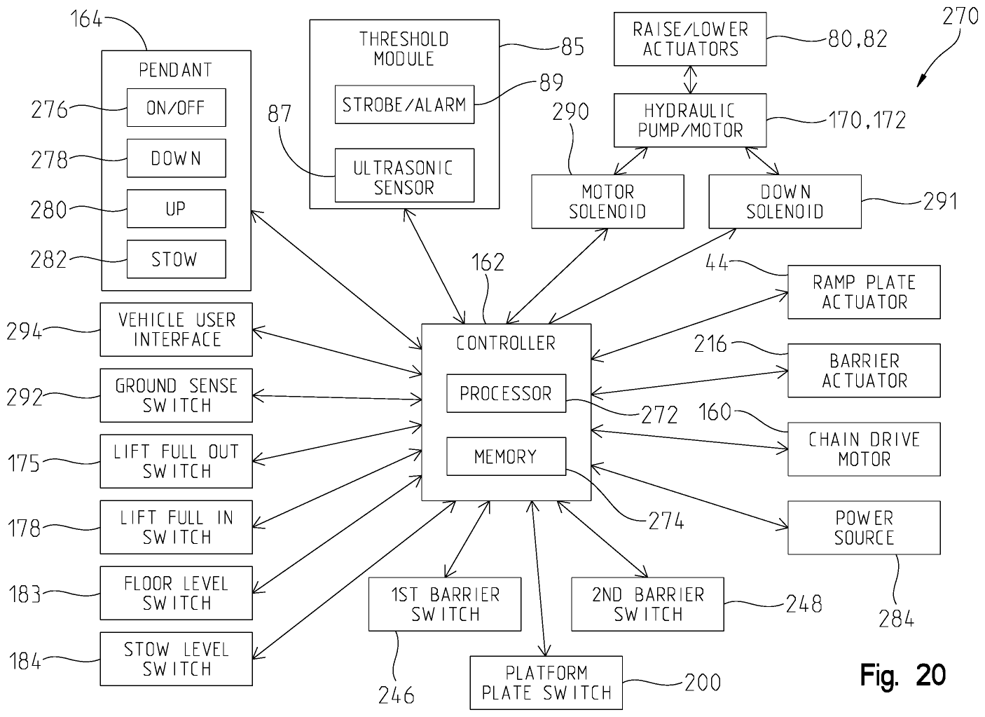

FIG. 20 is a block diagram of a control system 270 including the controller 162 which includes a processor 272 and a memory 274. The controller 162 is electrically connected, either directly or indirectly, to a number of components including both electrical and mechanical devices. The controller 162 includes one or more processors 272 (e.g. microprocessors), and the associated memory 274 including one or more random access memory (RAM) devices comprising the memory storage of the controller 162, as well as any supplemental levels of memory, e.g., cache memories, non-volatile or backup memories (e.g. programmable or flash memories), and read-only memories. In addition, the memory 274 can include an internal memory and/or a memory physically located elsewhere from the processing devices and can include any cache memory in a processing device, as well as any storage capacity used as a virtual memory, e.g., as stored on a mass storage device or another computer coupled to controller 162. Other embodiments include, but are not limited to a computer, computer system, or programmable device, e.g., multi-user or single-user computers which are configured to provide the features described herein.

The controller 162 executes or otherwise relies upon computer software applications, components, programs, objects, modules, or data structures, etc. Software routines resident in the included memory 274 of the controller 162, or other memory, are executed in response to the signals received. The computer software applications, in other embodiments, are located in the cloud. The executed software includes one or more specific applications, components, programs, objects, modules or sequences of instructions typically referred to as “program code”. The program code includes one or more instructions located in the memory and other storage devices that execute the instructions resident in memory, which are responsive to other instructions generated by the system, or which are provided at a user interface operated by the user 294. The processor 272 is configured to execute the stored program instructions as well as to access data stored in one or more data tables.

The controller 162 is coupled to the pendent 164 which includes an on/off button 276, a down button 278, an up button 280, and stow button 282. The on/off button 276 provides power to each of the buttons 278, 280 and 282. Once powered, each of these buttons is used to move the wheelchair lift 24 between loading, unloading, and stow positions. Power for the pendant 164 as well as for each of the electrical components, motors, or pumps, is provided by a power source 284. In one embodiment, the power source 284 is a 24 volt DC vehicle battery. Other power sources are contemplated.

If the lift 24 is stowed, pressing the up button 280 or down button 278 moves the lift 24 from the stowed position to a lift full-out position in which the lift 24 is fully extended from the housing 26. When the lift 24 is fully extended, the lift full out switch 175 transmits a signal to the controller 162 to indicate the platform 40 is positioned for raising to a loading position. Continued pressing of the up button 280 moves the platform 40 to a loading position at the bus floor 22.

Once the controller 162 receives the signal transmitted by the full out switch 175, a motor solenoid 290 is actuated by the controller 162 to energize the hydraulic pump/motor 170/172 to drive the actuators 80/82 for raising the platform 40 by rotating the cylinder 70 in a first direction. The platform 40 is raised until the floor level switch 183 determines that the platform plate 51 is level with the floor 22, the loading position. Upon reaching floor level, the floor level switch 183 transmits a signal to the controller 162, which in turn actuates the motor solenoid 290 to stop rotation of the cylinder 70 and thereby stop raising of the platform 40. Upon reaching the loading position, the controller 162 transmits a signal to the barrier actuator 216 to move the barrier, also known as the “inner barrier”, to a horizontal position. In this position, the barrier 52 is substantially planar with the transition plate 83 to enable a wheelchair and its passenger to move onto the platform plate 51. At this location, the ramp plate 42 is at a substantially vertical position.

Once the passenger is located on the platform plate 51, the operator presses the down button 278 which transmits a signal to the controller 162 to move the platform 40 to ground level. At this time and in response to actuation of the down button 278, the controller 162 transmits a signal to a down solenoid 291 which releases hydraulic pressure in the hydraulic pump/motor 170/172 that would maintain the platform 40 at its loading position if the down button 278 was not depressed. Once the down button 278 is pressed, the hydraulic pressure is released and the platform 40 moves downward in a controlled fashion to the ground surface. After the platform 40 reaches ground, a ground sense switch 292 determines that the hydraulic pressure has reached approximately zero pressure to indicate that the passenger located on the platform plate 51 can move from the platform to the ground surface. Upon receiving the signal from the ground sense switch 292, the controller 162 transmits a signal to the platform actuator 44 to move the ramp plate 42 from the substantially vertical position to a substantially horizontal position to enable the passenger in the wheelchair to move from the platform plate 51 to the ground surface. Once each passenger has exited the bus 10, pressing the stow button 282 moves the lift 24 to the stow position.

Upon pressing of the stow button, the lift 24 moves from the ground to a level aligned with the housing 26 which is a stow level. Once at the stow level, the lift 24 moves towards the housing 26 actuates the full out switch 175, at which point the lift 24 stops. By stopping the lift at this position, the operator or user is reminded to put the handrails 54 and 56 in the down position. Once the user has moved the handrails down, the operator presses the stow button 282 once more and the lift 24 moves to a full in position for complete storage of the lift 24.

When a passenger in a wheelchair arrives at the bus 10 for entry and the lift 24 is in the stow position, the operator checks to see if the power is on and if not, the operator presses the on/off button 276. Once pressed, the operator presses the down button 278. In response, the lift 24 moves to the fully extended position and then moves towards the ground surface. By pressing the down button 278, lift 24 continues to move to the ground surface, as described above, until the ground sense switch 292 determines that the platform 40 has reached ground level. At this time, the controller 162, determining that the platform has reached ground level, actuates the platform actuator 44 to move the ramp plate 42 to a horizontal position. At this time, the passenger moves onto the platform plate 51. Once situated, the operator presses the up button 280 which is continually pressed to start upward movement of the platform 40 toward the level of the bus floor 22. Once the floor level switch 183 detects that the platform plate 51 is at floor level, the controller 162, that receives a signal from the floor level switch 183, stops upward movement of the platform 44. At this point, the controller 162 actuates the barrier actuator 216 until the operator stops pressing the up button 280 to move the barrier 52 to a horizontal position with the transition plate 83. At this location, the passenger moves from the floor plate 51 and enters the bus 10. Once the passenger has entered the bus 10, a user presses the stow button 282 which moves the lift 24 to the stow position.

In one embodiment, the control system 270 of the vehicle 10 includes a vehicle user interface 294 that provides one or more indicators, either a visual indicator or an acoustic indicator. For instance, one indicator identifies the status of the stow location of the lift 24. If, for instance, the vehicle 10 is put into gear for moving into either a forward or reverse direction and the lift 24 has not been stored, the indicator signals that the lift is not stored. In one embodiment, in addition to the indicator providing a status of the lift 24, the vehicle includes an interlock that prevents the vehicle from being put into gear. In this case, the user interface is a physical indicator that shows the vehicle operator that an undesirable condition has occurred. In another embodiment, the vehicle user interface 294 includes a user display that displays different operating conditions or positions of the lift 24. For instance, position information such as platform at ground level or platform at floor level is displayed. Other operating conditions are contemplated.

As described herein, the lift assembly is configured for use in the ski locker of a bus or for use in other passenger vehicles having a similarly shaped compartment which does not accommodate skis. In some embodiments, a housing is provided to stow and support the lift assembly. In this configuration, the housing including the lift assembly is located where needed on the passenger vehicle. In addition, the features described are not limited to the described lift assembly and have utility in other types of lift assemblies.

While exemplary embodiments incorporating the principles of the present invention have been disclosed herein, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

1. A wheelchair lift for a passenger bus comprising:
a housing having sidewalls and a plurality of bearings;
a carriage supporting one or more of electrical, mechanical, and hydraulic components;
a lift assembly coupled to the housing, the lift assembly including a first rail and a second rail, the first rail and second rail supported by the plurality of bearings, a first scissor leg assembly coupled to the first rail and a second scissor leg assembly coupled to the second rail, wherein each of the first scissor leg assembly and the second scissor leg assembly move between an expanded and a collapsed condition; and
a platform coupled to the first scissor leg assembly and the second scissor leg assembly, wherein movement of the first scissor leg assembly and second scissor leg assembly between the expanded and collapsed condition adjusts a position of the platform for lifting a wheelchair.

2. The wheelchair lift of claim 1 wherein the carriage includes a front wall and the first rail and the second rail provide sidewalls of the housing, and a cylinder rotatably coupled to the front wall, wherein the cylinder is coupled to the first scissor leg assembly and to the second leg assembly and rotation of the cylinder expands and collapses the first and second leg assemblies.

3. The wheelchair lift of claim 2 wherein the first scissor leg assembly includes a first arm coupled to a first end of the cylinder and a second arm coupled to a second end of the cylinder, wherein rotation of the cylinder adjusts the position of the first arm and the second arm.

4. The wheelchair lift of claim 3 wherein the carriage includes a first actuator having a first piston rod coupled to the first arm and second actuator having a second piston rod coupled to the second arm, wherein extension and retraction of the first piston rod and the second piston rod rotates the cylinder to expand and to collapse the first and second leg assemblies.

5. The wheelchair lift of claim 4 further comprising a guide rail coupled to the housing, the guide rail supporting a chain and the housing includes a motor, wherein the chain is coupled to the motor and the motor upon actuation drives the chain to move the lift assembly to a stowed position.

6. The wheelchair lift of claim 5 further comprising a locator coupled to the bus, wherein the locator receives the housing in the stowed position.

7. The wheelchair lift of claim 5 wherein the first scissor leg assembly includes a third arm rotatably coupled to the first arm and the second scissor leg assembly includes a fourth arm rotatably coupled to the second arm, wherein the third arm is slidably connected to the first rail and the fourth arm is slidably connected to the second rail.

8. The wheelchair lift of claim 5 wherein the first arm and the second arm are each slidably connected to the platform.

9. The wheelchair lift of claim 8 wherein the third arm includes a first segment fixedly connected to a second segment at a pivot location at the first arm, wherein the first segment is slidably connected to the first rail and the second segment is rotatably coupled to the platform.

10. The wheelchair lift of claim 9 wherein the fourth arm includes a first segment fixedly connected to a second segment at a pivot location at the second arm, wherein the first segment is slidably connected to the second rail and the second segment is rotatably coupled to the platform.

11. The wheelchair lift of claim 2 further comprising a first switch having a contact arm and the cylinder includes a plate coupled thereto and located in proximity of the contact arm, wherein rotation of the cylinder rotates the plate into and out of contact with the contact arm to identify a position of the first arm and the second arm.

12. The wheelchair lift of claim 11 further comprising a second switch having a roller arm and the housing includes a contact plate, wherein movement of the carriage adjusts a position of the second switch with respect to the contact plate of the housing to stop movement of the carriage at the extended position.

13. The wheelchair lift of claim 12 further comprising a third switch having a roller arm and the locator includes a contact plate, wherein movement of the carriage adjusts a position of the third switch with respect to the contact plate of the locator to stop movement of the carriage at the stowed position.

14. The wheelchair lift of claim 13 wherein the carriage includes a motor and wherein the first switch, the second switch and the third switch, are each operatively connected to the motor.

15. A passenger bus comprising:
a body having an entrance and a storage compartment located below the entrance; and
a wheelchair lift includes a stowed position located within the storage compartment and having a deployed position extending from the storage compartment, the wheelchair lift including:
a housing having sidewalls and a plurality of bearings,
a carriage supporting one or more of electrical, mechanical, and hydraulic components,
a lift assembly coupled to the housing, the lift assembly including a first rail and a second rail, the first rail and second rail supported by the plurality of bearings,
a first scissor leg assembly coupled to the first rail and a second scissor leg assembly coupled to the second rail, wherein each of the first scissor leg assembly and the second scissor leg assembly move between an expanded and a collapsed condition, and
a platform coupled to the first scissor leg assembly and the second scissor leg assembly, wherein movement of the first scissor leg assembly and second scissor leg assembly between the expanded and collapsed condition adjusts a position of the platform.

16. The passenger bus of claim 15 wherein the carriage includes a front wall and the first rail and the second rail provide sidewalls of the carriage, and a cylinder rotatably coupled to the front wall, wherein the cylinder is coupled to the first scissor leg assembly and to the second leg assembly and rotation of the cylinder expands and collapses the first and second leg assemblies.

17. The passenger bus of claim 16 wherein the first scissor leg assembly includes a first arm coupled to a first end of the cylinder and a second arm coupled to a second end of the cylinder, wherein rotation of the cylinder adjusts the position of the first arm and the second arm.

18. The passenger bus of claim 17 wherein the carriage includes a first actuator having a first piston rod coupled to the first arm and second actuator having a second piston rod coupled to the second arm, wherein extension and retraction of the first piston rod and the second piston rod rotates the cylinder to expand and to collapse the first and second leg assemblies.

19. The passenger bus of claim 18 further comprising a guide rail coupled to the carriage, the guide rail supporting a chain and the carriage includes a motor, wherein the chain is coupled to the motor and the motor upon actuation drives the chain to move the lift assembly to a stowed position.

20. The passenger bus of claim 19 further comprising a locator coupled to the bus, wherein the locator receives the carriage in the stowed position.
